(19) United States
(12) Patent Application Publication
(10) Pub. No.: US 2012/0193185 A1
(43) Pub. Date: Aug. 2, 2012

(54) CLUTCH MEMBER ADAPTED TO REMAIN ENGAGED IN A FIXED POSITION WHILE UNDER A HEAVY LOAD

(75) Inventor: Peiliang P. Zhang, Shrewsbury, MA (US)

(73) Assignee: SIEMENS INDUSTRY, INC., Alpharetta, GA (US)

(21) Appl. No.: 13/018,942

(22) Filed: Feb. 1, 2011

(51) Int. Cl. F16D 11/14

(52) U.S. Cl. 192/69

(57) ABSTRACT

A releasable gear type spline clutch can couple a shaft to a wheel rotatably mounted on the shaft. The clutch comprises an annular clutch member axially mounted on the shaft. Mating external and internal first splines are provided respectively on the shaft and the dutch member, and mating external and internal second splines are provided respectively on the clutch member and the wheel. The pitch diameter of the second splines is greater than the pitch diameter of the first splines, and the pressure angle of the first splines is greater than the pressure angle of the second splines. The clutch member is axially shiftable between a disengaged position at which the second splines are out of mesh, and an engaged position at which the second splines are meshed. The first splines are meshed in both the engaged and disengaged positions.

### BACKGROUND

1. Field of the Invention

Embodiments of the present invention relate to clutch mechanisms and system and, more particularly, to gear type spline clutch systems.

2. Description of Related Art

When heavily loaded, gear type spline clutches exhibit a tendency to slip out of engagement. Prior attempts at addressing this problem have either been ineffective or unduly complicated and expensive.

### SUMMARY

Briefly described, embodiments of the present invention relate to an improved gear type spline clutch that is simple in design, yet fully effective in avoiding disengagement under heavy loads.

The releasable gear type spline clutch of the present invention is designed to couple a shaft to a wheel rotatably mounted on the shaft. The clutch comprises an annular clutch member axially mounted on the shaft at a location adjacent to the wheel. Mating external and internal first splines are provided respectively on the shaft and clutch member, and mating external and internal second splines are provided respectively on the clutch member and the wheel. The pitch diameter of the second splines is greater than the pitch diameter of the first splines. The clutch member is axially shiftable between a disengaged position at which the second splines are out of mesh, and an engaged position at which the second splines are meshed. The first splines remain meshed in both the engaged and disengaged positions of the clutch member.

In a preferred embodiment, the pressure angle of the first splines is greater than the pressure angle of the second splines.

These and other embodiments, objects, features, and advantages of the present invention will become more apparent upon reading the following specification in conjunction with the accompanying drawing figures.

### BRIEF DESCRIPTION OF THE DRAWINGS

FIG. 1 is a partial cross-sectional view of a clutch assembly illustrating the clutch member in an engaged position, in accordance with an exemplary embodiment of the present invention.

FIG. 2 is a cross sectional view of a portion of the clutch assembly taken along line 2-2 of FIG. 1, in accordance with an exemplary embodiment of the present invention.

FIG. 3 is a partial cross-sectional view of the clutch member, illustrating the clutch member in a disengaged position, in accordance with an exemplary embodiment of the present invention.

FIGS. 4A and 4B are enlarged views showing pressure angles of first and second splines of the clutch member, in accordance with an exemplary embodiment of the present invention.

FIG. 5 depicts pitch circles pitch diameters of the first and second splines, in accordance with an exemplary embodiment of the present invention.

### DETAILED DESCRIPTION

To fileilitate an understanding of embodiments, principles, and features of the present invention, they are explained hereinafter with reference to implementation in illustrative embodiments. In particular, they are described in the context of being a clutch member.

Embodiments of the present invention, however, are not limited to use in the described clutch member. Rather, embodiments of the present invention can be used when a clutch is desired or necessary.

The components and materials described hereinafter as making up the various embodiments are intended to be illustrative and not restrictive. Many suitable components and materials that would perform the same or a similar function as the materials described herein are intended to be embraced within the scope of embodiments of the present invention.

Referring now to the figures, wherein like reference numerals represent like parts throughout the views, embodiments of the present invention will be described in detail.

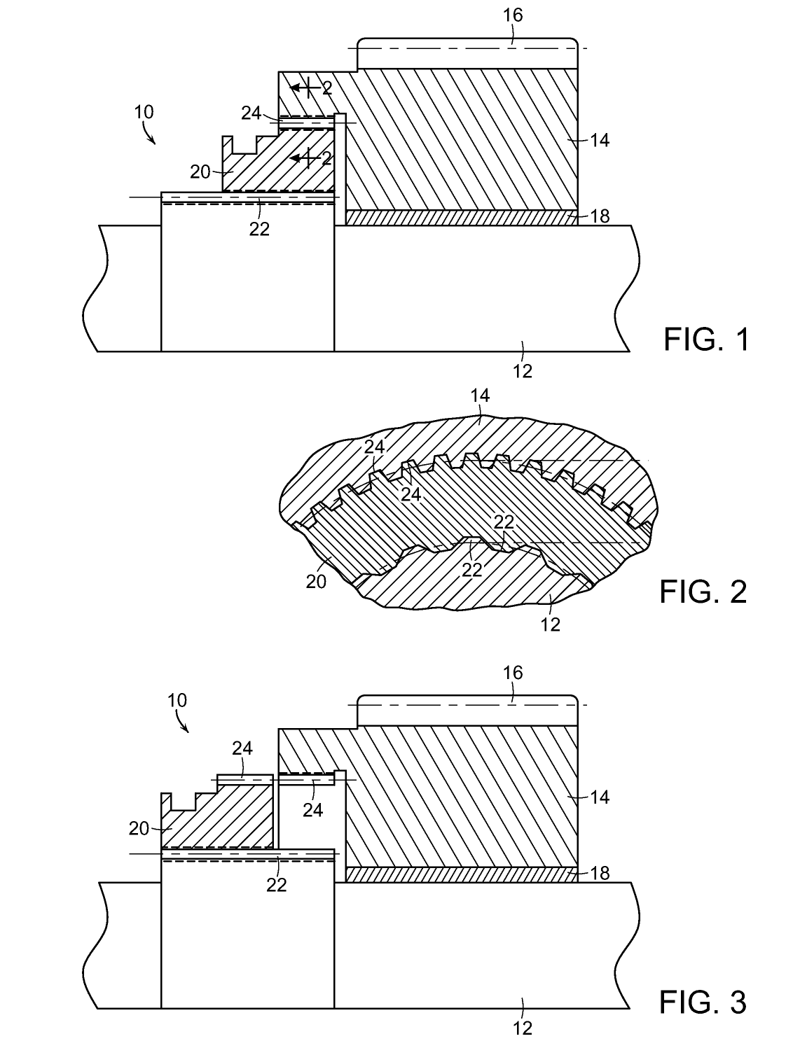

With reference initially to FIG. 1, a clutch assembly 10 of the present invention provides a means of coupling a shaft 12 to a wheel 14. The wheel 14, which may be a gear with external teeth 16, is rotatably supported on the shaft 12 by a sleeve bearing 18 or the like.

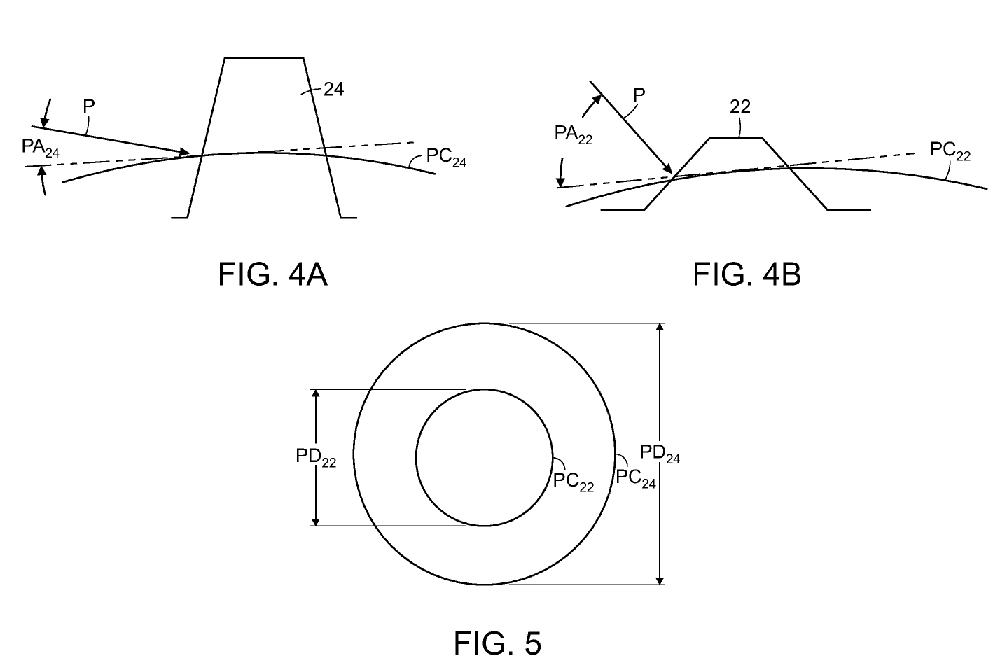

An annular clutch member 20 can be axially mounted on the shaft 12. With reference additionally to FIG. 2, mating external and internal first splines 22 are provided respectively on the shaft 12 and clutch member 20, and mating external and internal second splines 24 are provided respectively on the clutch member 20 and wheel 14. The pitch circles of the splines 22, 24 are respectively depicted at PC₂₂ and PC₂₄ in FIG. 5. The pitch diameter PD₂₄ of the second splines 24 is greater than the pitch diameter PD₂₂ of the first splines 22. Also, as can be seen by a comparison of FIGS. 4A and 4B, the pressure angle PA₂₂ of the first splines 22 is greater than the pressure angle PA₂₄ of the second splines 24. As herein employed, “pressure angle” means the angle at a pitch point between the line of pressure P normal to the tooth surface, and the plane tangent to the pitch circle.

For example and not limitation, if PD₂₂=R1, PD₂₄=R2, PA₂₂=A1, PA₂₄=A2, and SF is a variable service factor, then in an exemplary embodiment, the design criteria can be:

$$\frac{R 2}{R 1} • \frac{cos ( A 2 )}{cos ( A 1 )} \geq SF .$$

Therefore, for example and not limitation, if

$$SF = 2 , \\ \frac{R 2}{R 1} = 1.35 , \\ then$$

$$\frac{cos ( A 2 )}{cos ( A 1 )} = 1.48$$

or more to satisfy this criteria.

The clutch member 20 is axially shiftable between an engaged position as shown in FIG. 1, and a disengaged position as shown in FIG. 3. When the clutch member is in the engaged position, the second splines 24 are meshed, and when the clutch member is in the disengaged position, the second splines are out of mesh. The first splines 22 are engaged when the clutch member is in both positions.

The shaft 12, wheel 14, and clutch member 20 can be machined from the same material, and thus the mating surfaces of the first and second splines 22, 24 will have approximately the same coefficient of friction. In the course of transmitting torque between the shaft 12 and wheel 14 as a consequence of the clutch member 20 being in its engaged position, and because of the above described differential in pitch diameters as preferably augmented by the above described differential in pressure angles, slippage of the clutch member out of engagement is resisted by friction at the mating surfaces of the first splines 22 that is greater than and advantageously twice that of the friction at the mating surfaces of the second splines 24.

The friction differential effectively serves to resist slippage of the clutch member out of its engaged position when the clutch assembly is heavily loaded.

While the invention has been disclosed in exemplary forms, it will be apparent to those skilled in the art that many modifications, additions, and deletions can be made therein without departing from the spirit and scope of the invention and its equivalents, as set forth in the following claims.

What is claimed is:

1. A releasable gear type spline clutch for coupling a shaft to a wheel rotatably mounted on the shaft, said clutch comprising:
an annular clutch member axially mounted on said shaft;
mating external and internal first splines on respectively said shaft and said clutch member;
mating external and internal second splines on respectively said clutch member and said wheel, the pitch diameter of said second splines being greater than the pitch diameter of said first splines and the pressure angle of said first splines being greater than the pressure angle of said second splines;
said clutch member being axially shiftabl.e between a disengaged position at which said second splines are out of mesh, and an engaged position at which said second splines are meshed, said first splines being meshed in both said engaged and disengaged positions.

2. The releasable clutch of claim 1, wherein in the course of transmitting torque between said shaft and said wheel as a consequence of said clutch member being in its engaged position, shifting of said clutch member out of said engaged position is resisted by friction at the mating surfaces of said first splines that is greater than friction at the mating surfaces of said second splines.

3. The releasable clutch of claim 2, wherein the friction at the mating surfaces of said first splines is at least equal to or greater than the design Service Factor of about twice the friction of the mating surfaces at said second splines.

4. The releasable clutch of claim 1, wherein:
$$\frac{R 2}{R 1} • \frac{cos ( A 2 )}{cos ( A 1 )} \geq SF ,$$
where
R₁=pitch diameter of first splines (PD₂₂);
R₂=pitch diameter of second splines (PD₂₄);
A₁=pressure angle of first splines (PA₂₂);
A₂=pressure angle of second splines (PA₂₄); and
SF=variable service factor.

5. The releasable clutch of claim 2, wherein:
$$\frac{R 2}{R 1} • \frac{cos ( A 2 )}{cos ( A 1 )} \geq SF ,$$
where
R₁=pitch diameter of first splines (PD₂₂);
R₂=pitch diameter of second splines (PD₂₄);
A₁=pressure angle of first splines (PA₂₂);
A₂=pressure angle of second splines (PA₂₄); and
SF=variable service factor.

6. The releasable clutch of claim 3, wherein:
$$\frac{R 2}{R 1} • \frac{cos ( A 2 )}{cos ( A 1 )} \geq SF ,$$
where
R₁=pitch diameter of first splines (PD₂₂);
R₂=pitch diameter of second splines (PD₂₄);
A₁=pressure angle of first splines (PA₂₂);
A₂=pressure angle of second splines (PA₂₄); and
SF=variable service factor.
